(19) United States
(12) Patent Application Publication
(10) Pub. No.: US 2025/0257287 A1
(43) Pub. Date: Aug. 14, 2025

(54) AQUEOUS ACIDIC HARD SURFACE CLEANING LIQUID COMPOSITION

(71) Applicant: The Procter & Gamble Company, Cincinnati, OH (US)

(72) Inventors: Kathleen KIRKWOOD, Newcastle upon Tyne (GB); Eva Maria PEREZ-PRAT VINUESA, Vinhedo (São Paulo) (BR); Fernando Ray TOLLENS, Cincinnati, OH (US)

(21) Appl. No.: 19/054,379

(22) Filed: Feb. 14, 2025

Related U.S. Application Data
(63) Continuation of application No. PCT/US2025/015364, filed on Feb. 11, 2025.
(60) Provisional application No. 63/552,742, filed on Feb. 13, 2024.

(51) Int. Cl. C11D 1/66; C11D 3/20; C11D 3/43; C11D 17/00; C11D 17/04

(52) U.S. Cl. CPC C11D 1/662; C11D 3/2079; C11D 3/2086; C11D 3/43; C11D 17/0008; C11D 17/046; C11D 2111/14

(57) ABSTRACT

An aqueous acidic hard surface cleaning liquid composition containing alkyl polyglucoside surfactant, citric acid and formic acid.

### FIELD OF THE INVENTION

The present invention relates to hard surface cleaning. The present invention provides hard surface cleaning compositions that are liquid. The compositions of the present invention are aqueous and acidic. The compositions of the present invention comprise alkyl polyglucoside surfactant, citric acid, and formic acid. The compositions of the present invention have a pH in the range of from 1.9 to 3.5.

### BACKGROUND OF THE INVENTION

Hard surface cleaning products need to provide several different benefits, including good anti-bacterial performance and good shine performance. The present invention seeks to provide an aqueous acidic hard surface cleaning liquid composition having both a good anti-bacterial performance and good shine performance.

Ingredients such as citric acid cannot be formulated in hard surface cleaning compositions at high levels without negatively affecting the shine performance. In addition, high levels of citric acid can lead to a tendency of the treated surface to feel sticky to touch.

In addition, ingredients such as alkyl polyglucoside surfactant cannot be formulated in hard surface cleaning compositions at high levels without also negatively affecting the shine performance.

The present invention combines citric acid with formic acid as well as alkyl polyglucoside surfactant to provide an aqueous acidic hard surface cleaning liquid composition having both a good anti-bacterial performance and good shine performance.

The presence of formic acid allows for lower levels of other ingredients to be used whilst still providing good product performance.

This combination of alkyl polyglucoside surfactant levels, and the acid system (citric acid levels and formic acid levels) provides good shine performance and good anti-bacterial performance.

In addition, this level of anti-bacterial performance can be achieved without using quaternary ammonium compounds. This approach is more environmentally friendly.

### SUMMARY OF THE INVENTION

The present invention provides an aqueous acidic hard surface cleaning liquid composition, wherein the composition comprises by weight of the composition:
(a) from 0.10 wt % to 2.5 wt % alkyl polyglucoside surfactant;
(b) from 0.15 wt % to 4.00 wt % citric acid; and
(c) from 0.05 wt % to 1.00 wt % formic acid;

wherein the composition has a pH in the range of from 1.9 to 3.5.

The present invention also provides a cleaning kit for cleaning and sanitizing a hard surface, wherein the cleaning kit comprises:
(a) an aqueous acidic hard surface cleaning liquid composition of the present invention;
(b) a handle;
(c) a support head pivotally attached to said handle;
(d) a disposable cleaning substrate removably attached to the support head; and
(e) a liquid delivery system for providing the cleaning liquid composition (a) to a surface to be cleaned and sanitized.

### DETAILED DESCRIPTION OF THE INVENTION

### Aqueous Acidic Hard Surface Cleaning Liquid Composition

The aqueous acidic hard surface cleaning liquid composition comprises by weight of the composition:
(a) from 0.10 wt % to 2.5 wt % alkyl polyglucoside surfactant;
(b) from 0.15 wt % to 4.00 wt % citric acid; and
(c) from 0.05 wt % to 1.00 wt % formic acid;

wherein the composition has a pH in the range of from 1.9 to 3.5.

Preferably, the composition comprises, by weight of the composition:
(a) from 0.175 wt % to 3.0 wt % citric acid; and
(b) from 0.050 wt % to 0.5 wt % formic acid,

wherein the weight ratio of citric acid to formic acid is in the range of from 60:1 to 2.0:1.

Preferably, the composition comprises, by weight of the composition:
(a) from 0.5 wt % to 1.5 wt % citric acid; and
(b) from 0.050 wt % to 0.35 wt % formic acid,

wherein the weight ratio of citric acid to formic acid is in the range of from 30:1 to 3.0:1.

The composition may further comprise, by weight of the composition, from 0.05 wt % to 0.8 wt % glycolic acid, preferably from 0.1 wt % to 0.4 wt % glycolic acid.

Preferably, the composition comprises, by weight of the composition, from 0.10 wt % to 2.00 wt %, or from 0.10 wt % to 1.00 wt % alkyl polyglucoside surfactant.

Any suitable alkyl polyglucoside surfactant can be used. Preferably, the alkyl polyglucoside surfactant is a C₈-C₁₀ alkyl polyglucoside surfactant.

The composition may further comprise, by weight of the composition, from 0.1 wt % to 1.0 wt % ether alcohol solvent. Any suitable ether alcohol solvent can be used. Preferably, the ether alcohol solvent is selected from dipropylene glycol n-butyl ether, propylene glycol mono-butyl ether, -propylene glycol phenyl ether, and any combination thereof.

Preferably, the composition has a reserve acidity of at least 0.15 g NaOH per 100 g product measured at 25° C.

Preferably the composition has a reserve acidity per total acid level of at least 0.28 g NaOH per 100 g of product per total weight percent acid measured at 25° C.

Typically, the composition further comprises one or more of the following ingredients selected from perfume, pH stabilizer, dye, antifoam agent, polymer, additional surfactant, preservative, chelant, hydrotrope, and any combination thereof.

Typically, the composition comprises, by weight of the composition, from 88 wt % to 99.65 wt % water.

Preferably, the composition comprises, by weight of the composition:
(a) from 0.10 wt % to 1.00 wt % C₈-C₁₀ alkylpolyglucoside surfactant;
(b) from 0.50 wt % to 1.50 wt % citric acid;
(c) from 0.10 wt % to 0.30 wt % formic acid, and
(d) from 0.10 wt % to 0.70 wt % glycol ether solvent,

wherein the pH of the liquid cleaning composition is from 1.9 to 2.8.

The composition is formulated as a liquid composition. A preferred composition herein is an aqueous composition and therefore, preferably comprises water more preferably in an amount of from about 50% to about 99%, even more preferably of from about 60% to about 98% and most preferably about 70% to about 97% by weight of the total composition.

The solids content of the composition, at usage levels, is generally low, preferably from about 0.01 wt % to about 4.0 wt %, or from above 0.03 wt % to 4.0 wt %, more preferably from about 0.05 wt % to about 3.0 wt %, most preferably from about 0.10 wt % to about 2.0 wt %. Those skilled in the art will recognize that the aqueous compositions of the present invention can be made in the form of about 5×, about 10×, or even higher concentrates as desired, and then diluted prior use. This is expected particularly when the aqueous composition is sold as a liquid intended to be diluted in a bucket or other receptacle. The making of concentrated solutions can also be beneficial if the aqueous composition must be transported.

### Alkyl Polyglycoside Surfactant

Alkyl polyglycoside surfactants are biodegradable nonionic surfactants. Suitable alkyl polyglycosides for use herein are characterised by a hydrophobic alkyl chain and a saccharide hydrophilic group. These surfactants differ in the alkyl chain length, both linear and branched, and in the degree of polymerisation (DP) of the saccharide. Suitable alkyl polyglycoside surfactants can have the general formula CₙH₂ₙ₊₁O(C₆H₁₀O₅)ₓH wherein n is preferably from 8 to 16, more preferably 8 to 14, and x is at least 1. Any reducing saccharide containing 5 or 6 carbon atoms can be used, preferably the saccharide is derived from glucose, and most preferred alkylpolyglycosides are alkylpolyglucosides. Examples of suitable alkyl polyglucoside surfactants are the TRITON™ alkyl polyglucosides from Dow; Agnique PG, Disponil APG and Glucopon alkyl polyglucosides from BASF. Preferred alkyl polyglucoside surfactants are those where n is 8 to 12, more preferably 8 to 10, such as for example Glucopon 215 UP from BASF.

### Optional Ingredients

The composition can incorporate additional optional ingredients in addition to the essential ingredients required by the present invention. Suitable additional ingredients include surfactant, solvents and hydrotropes. The liquid composition may comprise a variety of other optional ingredients depending on the technical benefit aimed for and the surface treated. Suitable optional ingredients for use herein include perfume, pH stabilizer, dye, antifoam agent, polymer, additional surfactant, preservative, chelant, and any combination thereof.

### Surfactant

Additional surfactants can be non-ionic, anionic, cationic, zwitterionic or amphoteric, and mixtures thereof. The required surfactant is defined as any material with a hydrophobic component consisting of a hydrocarbon moiety with between about 6 carbon atoms and about 20 carbon atoms, and a hydrophilic head group. The purpose of the surfactant is improved wetting of the hard surfaces to be treated. The wetting properties of the surfactant are essential to the compositions of the invention. The hydrophobic tail of the surfactant can be linear or branched, aliphatic aromatic. The hydrophilic head group can consist of any group such that provides wetting properties. Said surfactant may be present in the compositions according to the present invention in amounts of from about 0.01% to about 15%, preferably of from about 0.01% to about 10%, and more preferably of from about 0.02% to about 7.5% by weight of the total composition. At actual product use levels, the additional surfactants are typically present at levels from about 0.01% to about 1.5%, more preferably from about 0.01% to about 1%, and more preferably of from about 0.03% to about 0.75% by weight of the total composition.

More specifically, groups of non-ionic surfactants that can be used in the context of the following invention are as follows:
(i) The polyethylene oxide condensates of alkyl phenols, e.g., the condensation products of alkyl phenols having an alkyl group containing from about 6 to about 12 carbon atoms in either a straight chain or branched chain configuration, with ethylene oxide, the said ethylene oxide being present in amounts equal to about 10 to about 25 moles of ethylene oxide per mole of alkyl phenol. The alkyl substituent in such compounds may be derived from polymerized propylene, diisobutylene, octane, and nonane.
(ii) Those derived from the condensation of ethylene oxide with the product resulting from the reaction of propylene oxide and ethylene diamine products, which may be varied, in composition depending upon the balance between the hydrophobic and hydrophilic elements, which is desired. Examples are to increase the water-solubility of the molecule as a whole and the liquid character of the products is retained up to the point where polyoxyethylene content is about 50% of the total weight of the condensation product; compounds containing from about 40% to about 80% polyoxyethylene by weight and having a molecular weight of from about 5000 to about 11000 resulting from the reaction of ethylene oxide groups with a hydrophobic base constituted of the reaction product of ethylene diamine and excess propylene oxide, said base having a molecular weight of the order of about 2500 to about 3000.
(iii) The condensation product of aliphatic alcohols having from about 6 to about 18 carbon atoms, in either straight chain or branched chain configuration, with ethylene oxide, propylene oxide, butylene oxide, and mixtures thereof, e.g., a coconut alcohol ethylene oxide condensate having from about 3 to about 15 moles of ethylene oxide per mole of coconut alcohol, the coconut alcohol fraction having from about 10 to about 14 carbon atoms; such materials are commonly known as ‘alkyl alkoxylates’ or ‘alcohol alkoxylates’. In some cases, an alkyl ethoxylates can have capping groups, meaning that they have the structure R₁-(EO)ₓR₂, where R₁ is a C₆-C₁₈ linear or branched moiety, x is from about 1 to about 15 and R₂, the capping group, is a about C₁ to about C₈ hydrocarbyl moiety. Suitable branched alkoxylated alcohol may be selected from the group consisting of: C₄-C₁₀ alkyl branched alkoxylated alcohols, and mixtures thereof. The branched alkoxylated alcohol can be derived from the alkoxylation of C₄-C₁₀ alkyl branched alcohols selected form the group consisting of: C₄-C₁₀ primary mono-alcohols having one or more C₁-C₄ branching groups. By C₄-C₁₀ primary mono-alcohol, it is meant that the main chain of the primary mono-alcohol has a total of from 4 to 10 carbon atoms. The C₄-C₁₀ primary mono-alcohol can be selected from the group consisting of: methyl butanol, ethyl butanol, methyl pentanol, ethyl pentanol, methyl hexanol, ethyl hexanol, propyl hexanol, dimethyl hexanol, trimethyl hexanol, methyl heptanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol and mixtures thereof.
   The C₄-C₁₀ primary mono-alcohol can be selected from the group consisting of: ethyl hexanol, propyl hexanol, ethyl heptanol, propyl heptanol, ethyl octanol, propyl octanol, butyl octanol, ethyl nonanol, propyl nonanol, butyl nonanol, and mixtures thereof.
   Preferably the C₄-C₁₀ primary mono-alcohol is selected from the group consisting of: ethyl hexanol, propyl hexanol, ethyl heptanol, propyl heptanol, and mixtures thereof.
   The C₄-C₁₀ primary mono-alcohol is most preferably ethyl hexanol, and propyl heptanol.
   In the branched alkoxylated alcohol, the one or more C₁-C₄ branching group can be substituted into the C₄-C₁₀ primary mono-alcohol at a C₁ to C₃ position, preferably at the C₁ to C₂ position, more preferably at the C₂ position, as measured from the hydroxyl group of the starting alcohol.
   The branched alkoxylated alcohol can comprise from 1 to 14, preferably from 2 to 7, more preferably from 4 to 6 ethoxylate units, and optionally from 1 to 9, preferably from 2 to 7, more preferably from 4 to 6 of propoxylate units.
   The branched alkoxylated alcohol is preferably 2-ethyl hexan-1-ol ethoxylated to a degree of from 4 to 6, and propoxylated to a degree of from 4 to 6, more preferably, the alcohol is first propoxylated and then ethoxylated. Another preferred branched alkoxylated alcohols are 2-alkyl-1-alkanols such as alkoxylated C₁₀ guerbet alcohols with 1 to 14, preferably from 2 to 7, more preferably from 3 to 6 ethoxylate units.
   Non-limiting examples of suitable branched alkoxylated alcohols are, for instance, Ecosurf® EH3, EH6, and EH9, commercially available from DOW, and Lutensol XP alkoxylated Guerbet alcohols & Lutensol XL ethoxylated Guerbet alcohols available from BASF.

Other suitable surfactants are alkyl glucamide surfactants. Glucamide surfactants are non-ionic surfactants in which the hydrophilic moiety (an amino-sugar derivative) and the hydrophobic moiety (a fatty acid) are linked via amide bonds. Particularly preferred alkyl glucamide surfactants are N-alkyl-N-acylglucamides of the formula (I):

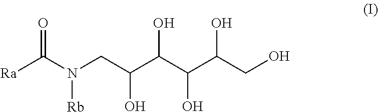

wherein Ra is a linear or branched, saturated or unsaturated hydrocarbyl group having 6 to 22 carbon atoms, and Rb is a C1-C4 alkyl radical. Particularly preferably, Rb in formula (I) is a methyl radical.

Non-limiting examples of suitable glucamide surfactants are: N-octanoyl-N-methylglucamide, N-nonanoyl-N-methylglucamide, N-decanoyl-N-methylglucamide, N-dodecanoyl-N-methylglucamide, N-cocoyl-N-methylglucamide (available under the trade name of GlucoPure Foam by Clariant), N-lauroyl/myristoyl-N-methylglucamide (available under the trade name of GlucoPure Deg by Clariant), and N-octanoyl/decanoyl-N-methylglucamine (available under the trade name of GlucoPure Wet by Clariant).

Although not preferred, the condensation products of ethylene oxide with a hydrophobic base formed by the condensation of propylene oxide with propylene glycol are also suitable for use herein. The hydrophobic portion of these compounds will preferably have a molecular weight of from about 1500 to about 1800 and will exhibit water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially available Pluronic® surfactants, marketed by BASF. Chemically, such surfactants have the structure (EO)ₓ(PO)_{y}(EO)_{z} or (PO)ₓ(EO)_{y}(PO)_{z} wherein x, y, and z are from about 1 to about 100, preferably about 3 to about 50. Pluronic® surfactants known to be good wetting surfactants are more preferred. A description of the Pluronic® surfactants, and properties thereof, including wetting properties, can be found in the brochure entitled BASF Performance Chemicals Plutonic® & Tetronic® Surfactants”, available from BASF.

Other non-ionic surfactants, though not preferred, for use herein include polyhydroxy fatty acid amides of the structural formula:

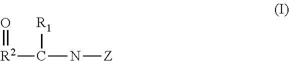

wherein: R¹ is H, C₁-C₄ hydrocarbyl, 2-hydroxy ethyl, 2-hydroxypropyl, or a mixture thereof, preferably C₁-C₄ alkyl, more preferably C₁ or C₂ alkyl, most preferably C₁ alkyl (i.e., methyl); and R² is a C₅-C₃₁ hydrocarbyl, preferably straight chain C₇-C₁₉ alkyl or alkenyl, more preferably straight chain C₉-C₁₇ alkyl or alkenyl, most preferably straight chain C₁₁-C₁₇ alkyl or alkenyl, or mixtures thereof; and Z is a polyhydroxyhydrocarbyl having a linear hydrocarbyl chain with at least about 3 hydroxyls directly connected to the chain, or an alkoxylated derivative (preferably ethoxylated or propoxylated) thereof. Z preferably will be derived from a reducing sugar in a reductive amination reaction; more preferably Z is a glycityl. Suitable reducing sugars include glucose, fructose, maltose, lactose, galactose, mannose, and xylose. As raw materials, high dextrose corn syrup can be utilised as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ'CH₂OH, —CH(CH₂OH)—(CHOH)ₙ₋₁—CH₂OH, —CH₂—(CHOH)₂(CHOR′)(CHOH)—CH₂OH, where n is an integer from about 3 to about 5, inclusive, and R′ is H or a cyclic or aliphatic monosaccharide, and alkoxylated derivatives thereof. Most preferred are glycityls wherein n is 4, particularly-CH₂—(CHOH)₄—CH₂OH.

In Formula (I), R¹ can be, for example, N-methyl, N-ethyl, N-propyl, N-isopropyl, N-butyl, N-2-hydroxy ethyl, or N-2-hydroxy propyl, R²—CO—N< can be, for example, cocamide, stearamide, oleamide, lauramide, myristamide, capricamide, palmitamide, tallowamide, etc., Z can be 1-deoxyglucityl, 2-deoxyfructityl, 1-deoxymaltityl, 1-deoxylactityl, 1-deoxygalactityl, 1-deoxymannityl, 1-deoxymaltotriotityl, etc.

Another type of suitable non-ionic surfactants for use herein are the 2-alkyl alkanols having an alkyl chain comprising from about 6 to about 16, preferably from about 7 to about 13, more preferably from about 8 to about 12, most preferably from about 8 to about 10 carbon atoms and a terminal hydroxy group, said alkyl chain being substituted in the a position (i.e., position number 2) by an alkyl chain comprising from about 1 to about 10, preferably from about 2 to about 8 and more preferably about 4 to about 6 carbon atoms.

Such suitable compounds are commercially available, for instance, as the Isofol® series such as Isofol® 12 (2-butyl octanol) or Isofol® 16 (2-hexyl decanol) commercially available from Condea.
A detailed listing of suitable non-ionic surfactants useful in this invention can be found in U.S. Pat. No. 4,557,853, Collins, issued Dec. 10, 1985.

Other suitable surfactants are amine oxide surfactants. Suitable amine oxide surfactants include: R₁R₂R₃NO wherein each of R₁, R₂ and R₃ is independently a saturated or unsaturated, substituted or unsubstituted, linear or branched hydrocarbon chain having from 1 to 30 carbon atoms. Preferred amine oxide surfactants are amine oxides having the following formula: R₁R₂R₃NO wherein R1 is a hydrocarbon chain comprising from 1 to 30 carbon atoms, preferably from 6 to 20, more preferably from 8 to 16 and wherein R₂ and R₃ are independently saturated or unsaturated, substituted or unsubstituted, linear or branched hydrocarbon chains comprising from 1 to 4 carbon atoms, preferably from 1 to 3 carbon atoms, and more preferably are methyl groups. R1 may be a saturated or unsaturated, substituted or unsubstituted linear or branched hydrocarbon chain.

Highly preferred amine oxides are C₈ dimethyl amine oxide, C₁₀ dimethyl amine oxide, C₁₂-C₁₄ dimethyl amine oxide, and C₁₄ dimethyl amine oxide. C₈ dimethyl amine oxide is commercially available under the trade name Genaminox® OC from Clariant; C₁₀ dimethyl amine oxide is commercially available under the trade name Genaminox® K-10 from Clariant; C₁₂-C₁₄ dimethyl amine oxide is commercially available under the trade name Genaminox® LA from Clariant and of Empigen OB from Huntsman; C₁₄ amine oxide is commercially available under the trade name of Empigen OH 25 from Huntsman. Other suitable amine oxide surfactants are cocoyldiethoxy amine oxide available under the trade name of genaminox CHE from Clariant, and cocamydopropyl amine oxide is commercially available under the trade name of empigen OS/A from Huntsman. Particularly preferred are C₁₂-C₁₄ dimethyl amine oxide surfactants.

Cationic surfactants are not preferred but can be used at low levels in compositions of the present invention are those having a long-chain hydrocarbyl group. Examples of such cationic surfactants include the ammonium surfactants such as alkyldimethylammonium halogenides, and those surfactants having the formula:

[R²(OR³)_{y}][R⁴(OR³)_{y}]₂R⁵N⁺X⁻

wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl ring structures formed by joining the two R⁴ groups, —CH₂CHOH—CHOHCOR⁶CHOHCH₂OH wherein R⁶ is any hexose or hexose polymer having a molecular weight less than about 1000, and hydrogen when y is not 0; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

Other cationic surfactants useful herein are also described in U.S. Pat. No. 4,228,044, Cambre, issued Oct. 14, 1980.

### Anionic Surfactants

If anionic surfactant is present, it is preferably present at low levels. The anionic surfactant can be selected from the group consisting of: an alkyl sulphate, an alkyl alkoxylated sulphate, a sulphonic acid or sulphonate surfactant, polycarboxylated anionic surfactants, and any mixture thereof. The composition can comprise up to 2.0 wt %, preferably up to 1.0 wt %, more preferably up to 0.1 wt % of anionic surfactant.

Suitable polycarboxylated anionic surfactants can be selected from the group consisting of: polyalkoxylate polycarboxylated surfactants, and mixtures thereof. Suitable polycarboxylated anionic surfactants are described in U.S. Pat. No. 5,376,298, EP0129328, WO03018733, and U.S. Pat. No. 5,120,326. Suitable polyalkoxylate polycarboxylated surfactant can have the empirical formula:

R—O—(CH(x)-CH(y)-O)n-R1

wherein R is a hydrophobic group, preferably a substituted, or unsubstituted, hydrocarbon group typically containing from 6 to 16 carbon atoms, preferably from 8 to 14 carbon atoms, x and y are each independently selected from the group consisting of hydrogen, methyl, and succinic acid radicals, with the proviso that at least one x or y moiety per molecule is a succinic acid radical, wherein n is between 1 and 60, and wherein R1 is hydrogen, substituted hydrocarbon, unsubstituted hydrocarbon preferably having between 1 and 8 carbon atoms, sulfuric, or sulfonic radical, with any acid groups being neutralized by compatible cationic groups, e.g., sodium, potassium, alkanolammonium, magnesium, etc.

Suitable polyalkoxylate polycarboxylates surfactant can have the empirical formula:

R—O—(C₂H₄O)ₓ—[CH(L)CH(L)]_{y}-[CH₂CH(CH₃)O)_{z}Q

wherein R is a hydrocarbon hydrophobic group, preferably alkyl, containing from 6 to 16, preferably from 8 to 14 carbon atoms; x is a number from 0 to 60, preferably from 4 to 50, more preferably from 6 to 50; L is either a C₁₋₃ alkyl group or a group having the formula —CH—(COO—) CH₂(COO—), with at least one L group in each molecule being —CH(COO—)CH₂(COO—); y is a number from 1 to 12, preferably from 2 to 10, more preferably from 3 to 8; z is a number from 0 to 20, preferably from 0 to 15, more preferably from 0 to 10; and Q is selected from the group consisting of H and sulfonate groups, the compound being rendered electrically neutral by the presence of cationic groups, preferably selected from the group consisting of sodium, potassium, and substituted ammonium, e.g., monocthanol ammonium, cations. Specific examples of such polyalkoxylate polycarboxylate surfactant include the following: Poly-Tergent® C9-51B (CS-1) (x=12; y=8; and Z=17); Poly-Tergent® C9-62P (x=4; y=3; and z=17); Poly-Tergent® C9-74P (x=10; y=3.5; and Z=3 5.); and Poly-Tergent® C9-92 (x=approximately 55; y=6.5; and z=0). R is believed to be an alkyl group such as a linear C9 alkyl group, and Q is believed to be H. The Poly-Tergent® surfactants are now sold under the Plurafac® trade name by BASF.

Suitable polycarboxylated anionic surfactants include alkoxylated polymer, alkyl ether, alkanedioic acid salts, for instance, as sold those under the Plurafac™ CS-10 tradename by BASF.

Suitable alkyl sulphates for use herein include water-soluble salts or acids of the formula ROSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like).

Particularly suitable linear alkyl sulphates include C₁₂₋₁₄ alkyl sulphate like EMPICOL® 0298/, EMPICOL® 0298/F or EMPICOL® XLB commercially available from Huntsman. By “linear alkyl sulphate” it is meant herein a non-substituted alkyl sulphate wherein the linear alkyl chain comprises from 6 to 16 carbon atoms, preferably from 8 to 14 carbon atoms, and more preferably from 10 to 14 carbon atoms, and wherein this alkyl chain is sulphated at one terminus.

Suitable sulphonated anionic surfactants for use herein are all those commonly known by those skilled in the art. Preferably, the sulphonated anionic surfactants for use herein are selected from the group consisting of: alkyl sulphonates; alkyl aryl sulphonates; naphthalene sulphonates; alkyl alkoxylated sulphonates; and C₆-C₁₆ alkyl alkoxylated linear or branched diphenyl oxide disulphonates; and mixtures thereof.

Suitable alkyl sulphonates for use herein include water-soluble salts or acids of the formula RSO₃M wherein R is a C₆-C₁₈ linear or branched, saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₁₈ linear or branched saturated or unsaturated alkyl group, preferably a C₈-C₁₆ alkyl group and more preferably a C₁₀-C₁₆ alkyl group, and M is H or a cation, e.g., an alkali metal cation (e.g., sodium, potassium, lithium, calcium, magnesium and the like) or ammonium or substituted ammonium (e.g., methyl-, dimethyl-, and trimethyl ammonium cations and quaternary ammonium cations, such as tetramethyl-ammonium and dimethyl piperidinium cations and quaternary ammonium cations derived from alkylamines such as ethylamine, diethylamine, triethylamine, and mixtures thereof, and the like).

Particularly suitable linear alkyl sulphonates include C₁₂-C₁₆ paraffin sulphonate like Hostapur® SAS commercially available from Clariant. Particularly preferred alkyl aryl sulphonates are alkyl benzene sulphonates commercially available under trade name Nansa® available from Huntsman.

By “linear alkyl sulphonate” it is meant herein a non-substituted alkyl sulphonate wherein the alkyl chain comprises from 6 to 18 carbon atoms, preferably from 8 to 16 carbon atoms, and more preferably from 10 to 16 carbon atoms, and wherein this alkyl chain is sulphonated at one terminus.

Suitable alkoxylated sulphonate surfactants for use herein are according to the formula R(A)mSO₃M, wherein R is an unsubstituted C₆-C₁₈ alkyl, hydroxyalkyl or alkyl aryl group, having a linear or branched C₆-C₁₈ alkyl component, preferably a C₈-C₁₆ alkyl or hydroxyalkyl, more preferably C₁₂-C₁₆ alkyl or hydroxyalkyl, and A is an ethoxy or propoxy or butoxy unit, and m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulphonates, alkyl butoxylated sulphonates as well as alkyl propoxylated sulphonates are contemplated herein. Specific examples of substituted ammonium cations include methyl-, dimethyl-, trimethyl-ammonium and quaternary ammonium cations, such as tetramethyl-ammonium, dimethyl piperidinium and cations derived from alkanolamines such as ethylamine, diethylamine, triethylamine, mixtures thereof, and the like.

Exemplary surfactants are C₁₂-C₁₈ alkyl polyethoxylate (1.0) sulphonate (C₁₂-C₁₈E(1.0)SM), C₁₂-C₁₈ alkyl polyethoxylate (2.25) sulphonate (C₁₂-C₁₈E(2.25)SM), C₁₂-C₁₈ alkyl polyethoxylate (3.0) sulphonate (C₁₂-C₁₈E(3.0)SM), and C₁₂-C₁₈ alkyl polyethoxylate (4.0) sulphonate (C₁₂-C₁₈E(4.0)SM), wherein M is conveniently selected from sodium and potassium. Particularly suitable alkoxylated sulphonates include alkyl aryl polyether sulphonates like Triton X-200® commercially available from Dow Chemical.

Preferably said sulphated or sulphonated anionic surfactant for use herein is selected from the group consisting of alkyl sulphates (AS) preferably C₁₂, C₁₃, C₁₄ and C₁₅ AS, sodium linear alkyl benzene sulphonate (NaLAS), linear alkyl benzene sulphonic acid, sodium paraffin sulphonate NaPC₁₂₋₁₆S, and mixtures thereof. Most preferably sulphated or sulphonated anionic surfactant for use herein is selected from the group consisting of alkyl sulphates (AS) preferably, C₁₂, C₁₃, C₁₄ and C₁₅ AS, sodium linear alkyl benzene sulphonate (NaLAS), linear alkyl benzene sulphonic acid, sodium paraffin sulphonate NaPC₁₂₋₁₆S and mixtures thereof.

### Solvents

As an optional but highly preferred ingredient, the composition herein comprises one or more solvents or mixtures thereof. Solvents can provide improved filming and/or streaking benefits. Whilst not wishing to be limited by theory, it is believed that solvents disrupt micelle formation, thus reducing surfactant aggregation. As such, they act as gloss toning agents, reducing gloss loss or promoting gloss gain on the surfaces of the present invention. Solvents are also beneficial because of their surface tension reduction properties help the cleaning profile of the compositions disclosed herein. Finally, solvents, particularly solvents with high vapour pressure, specifically vapour pressures of about 0.05 mm Hg at 25° C. and 1 atmosphere pressure (about 6.66 Pa) or higher, can provide cleaning and filming and/or streaking benefits without leaving residue.

Solvents for use herein include all those known in the art for use in hard-surface cleaner compositions. Suitable solvents can be selected from the group consisting of: aliphatic alcohols, ethers and diethers having from about 4 to about 14 carbon atoms, preferably from about 6 to about 12 carbon atoms, and more preferably from about 8 to about 10 carbon atoms; glycols or alkoxylated glycols; glycol ethers; alkoxylated aromatic alcohols; aromatic alcohols; terpenes; and mixtures thereof. Aliphatic alcohols and glycol ether solvents are most preferred, particularly those with vapour pressure of about 0.05 mm Hg at 25° C. and 1 atmosphere pressure (about 6.66 Pa).

Aliphatic alcohols, of the formula R—OH wherein R is a linear or branched, saturated or unsaturated alkyl group of from about 1 to about 20 carbon atoms, preferably from about 2 to about 15 and more preferably from about 5 to about 12, are suitable solvents. Suitable aliphatic alcohols are methanol, ethanol, propanol, isopropanol or mixtures thereof. Among aliphatic alcohols, ethanol and isopropanol are most preferred because of their high vapour pressure and tendency to leave no residue.

Suitable glycols to be used herein are according to the formula HO—CR₁R₂—OH wherein R₁ and R₂ are independently H or a C₂-C₁₀ saturated or unsaturated aliphatic hydrocarbon chain and/or cyclic. Suitable glycols to be used herein are dodecaneglycol and/or propanediol.

In one preferred embodiment, at least one glycol ether solvent is incorporated in the compositions of the present invention. Particularly preferred glycol ethers have a terminal C₃-C₆ hydrocarbon attached to from one to three ethylene glycol or propylene glycol moieties to provide the appropriate degree of hydrophobicity and, preferably, surface activity. Examples of commercially available solvents based on ethylene glycol chemistry include mono-ethylene glycol n-hexyl ether (Hexyl Cellosolve®) available from Dow Chemical. Examples of commercially available solvents based on propylene glycol chemistry include the di-, and tri-propylene glycol derivatives of propyl and butyl alcohol, which are available from Arco under the trade names Arcosolv® and Dowanol®.

In the context of the present invention, preferred solvents are selected from the group consisting of mono-propylene glycol mono-propyl ether, di-propylene glycol mono-propyl ether, mono-propylene glycol mono-butyl ether, di-propylene glycol mono-propyl ether, di-propylene glycol mono-butyl ether; tri-propylene glycol mono-butyl ether; ethylene glycol mono-butyl ether; di-ethylene glycol mono-butyl ether, ethylene glycol mono-hexyl ether; di-ethylene glycol mono-hexyl ether; and propylene glycol phenyl ether and mixtures thereof. “Butyl” includes normal butyl, isobutyl and tertiary butyl groups.

Dipropylene glycol n-butyl ether, propylene glycol mono-butyl ether, and propylene glycol phenyl ether are the most preferred cleaning solvent and are available under the tradenames Dowanol DPnPR, Dowanol PnB®, and Dowanol PPh® from Dow Inc.

The solvent can be purified so as to minimize impurities. Such impurities include aldehydes, dimers, trimers, oligomers and other by-products. These have been found to deleteriously affect product odour, perfume solubility and end result. The inventors have also found that common commercial solvents, which contain low levels of aldehydes, can cause irreversible and irreparable yellowing of certain hard surfaces. By purifying the cleaning solvents so as to minimize or eliminate such impurities, surface damage is attenuated or eliminated.

Though not preferred, terpenes can be used in the present invention. Suitable terpenes to be used herein monocyclic terpenes, dicyclic terpenes and/or acyclic terpenes. Suitable terpenes are: D-limonene; pinene; pine oil; terpinene; terpene derivatives as menthol, terpineol, geraniol, thymol; and the citronella or citronellol types of ingredients.

Suitable alkoxylated aromatic alcohols to be used herein are according to the formula R-(A)ₙ-OH wherein R is an alkyl substituted or non-alkyl substituted aryl group of from about 1 to about 20 carbon atoms, preferably from about 2 to about 15 and more preferably from about 2 to about 10, wherein A is an alkoxy group preferably butoxy, propoxy and/or ethoxy, and n is an integer of from about 1 to about 5, preferably about 1 to about 2. Suitable alkoxylated aromatic alcohols are benzoxyethanol and/or benzoxypropanol.

Suitable aromatic alcohols to be used herein are according to the formula R—OH wherein R is an alkyl substituted or non-alkyl substituted aryl group of from about 1 to about 20 carbon atoms, preferably from about 1 to about 15 and more preferably from about 1 to about 10. For example a suitable aromatic alcohol to be used herein is benzyl alcohol.

### Hydrotropes

Hydrotropes are advantageously used to ensure solubility of the composition, and in particular to ensure adequate perfume solubility. Hydrotropes include the sulfonates of toluene, xylene and cumene, sulfates of naphthalene, anthracene, and higher aromatics, and C₃-C₁₀ linear or branched alkyl benzenes, C₆-C₈ sulfates such as hexyl sulfate and 2-ethyl-1-hexyl sulfate, short chain pyrrolidones such as octyl pyrrolidone, and the like. Other preferred hydrotropes include the oligomers and polymers comprising polyethylene glycol. In a particularly preferred embodiment, alkyl ethoxylates comprising at least an average of about 15 moles of ethylene oxide, more preferably at least about 20 moles of ethylene oxide per mole chain length (alcohol) are advantageously employed. Unlike conventional hydrotropes, the preferred alkyl ethoxylate hydrotropes are found to have little or no impact on the filming and streaking properties of the compositions of the present invention. When present, hydrotropes are preferably used at solution weight percent of from about 0.01% to about 5%, more preferably about 0.01% to about 0.5%, still more preferably about 0.03% to about 0.25%.

### Polymers

The composition may comprise a polymer. The polymer can be selected from the group consisting of: a vinylpyrrolidone homopolymer (PVP); a polyethyleneglycol dimethylether (DM-PEG); a vinylpyrrolidone/dialkylaminoalkyl acrylate or methacrylate copolymers; a polystyrenesulphonate polymer (PSS); a poly vinyl pyridine-N-oxide (PVNO); a polyvinylpyrrolidone/vinylimidazole copolymer (PVP-VI); a polyvinylpyrrolidone/polyacrylic acid copolymer (PVP-AA); a polyvinylpyrrolidone/vinylacetate copolymer (PVP-VA); a polyacrylic polymer or polyacrylicmaleic copolymer; a maleic acid/alkyl vinyl ether copolymer and a polyacrylic or polyacrylic maleic phosphono end group copolymer; and mixtures thereof.

Typically, the composition may comprise from 0.005% to 5.0 wt % by weight of the total composition, of said polymer, preferably from 0.10 wt % to 4.0 wt %, more preferably from 0.1 wt % to 3.0 wt % and most preferably from 0.20 wt % to 1.0 wt %.

### Packaging Form of the Composition

The composition can be packaged in any container that allows proper dispensing of product. Such packages include, but are not limited to, capped bottled, and spray bottles. The packages can be made of any material known in the art, such as plastic or glass.

The composition can be sold in combination with other cleaning tools and/or implements. For example, the compositions can be sold together with sponges or sponge mops. Alternatively, the compositions are bundled with commercial paper towels, or with string or strip mops.

Preferably, the aqueous compositions are packaged in spray bottles and bundled, or co-branded with a cleaning implement (spray and mop application). Highly preferably, the composition is packaged with absorbent disposable cleaning pads and/or cleaning implements. Kits can also be sold where such pads are combined with a dispensing bottle containing composition of the present invention, optionally packaged together with a cleaning implement. These latter embodiments can be advantageously marketed and sold as ‘starter kits’, designed to help consumers leverage all the power of the composition.

### Cleaning Kit for Cleaning and Sanitizing a Hard Surface

The cleaning kit comprises:
(a) an aqueous acidic hard surface cleaning liquid composition of the present invention;
(b) a handle;
(c) a support head pivotally attached to said handle;
(d) a disposable cleaning substrate removably attached to the support head; and
(e) a liquid delivery system for providing the cleaning liquid composition (a) to a surface to be cleaned and sanitized.

A preferred aqueous acidic hard surface cleaning liquid composition for use in the cleaning kit comprises, by weight of the composition:
(a) from 0.1 wt % to 1 wt % C₈-C₁₀ alkyl polyglucoside surfactant;
(b) from 0.5 wt % to 1.5 wt % citric acid;
(c) from 0.1 wt % to 0.3 wt % formic acid, and
(d) from 0.1 wt % to 0.7 wt % glycol ether solvent,
wherein the pH of the liquid cleaning composition is from 1.9 to 2.8.

### Process for Cleaning a Surface

The process of cleaning a surface, preferably a hard surface, typically comprises the step of contacting, preferably wiping, said surface using the composition of the present invention. Preferably, the process comprises the steps of contacting parts of said surface, more preferably soiled parts of said surface, with said composition.

By “hard-surfaces”, it is meant herein any kind of surfaces typically found in houses like kitchens, bathrooms, e.g., floors, walls, tiles, windows, sinks, showers, shower plastified curtains, wash basins, WCs, dishes, fixtures and fittings and the like made of different materials like ceramic, vinyl, no-wax vinyl, linoleum, melamine, glass, any plastics, plastified wood, metal or any painted or varnished or sealed surface and the like. Hard surfaces also include household appliances including, but not limited to, refrigerators, freezers, washing machines, automatic dryers, ovens, microwave ovens, dishwashers and so on.

### EXAMPLES

### Methods

### Antibacterial Efficacy

### Bacterial Inoculum Preparation for Test

The bacteria inoculum was prepared by transferring several colonies from a Tryptone Soy Agar (TSA) plate to a saline solution (0.85% NaCl), the bacteria concentration in this saline solution was determined by measuring the % Transmittance at 425 nm and adjusted by either adding more bacteria or more saline solution until the % Transmittance at 425 nm was between 23-25% for Staphylococcus aureus ATCC 6358 (S.a.). This % transmittance corresponds to a bacteria concentration of 10⁸ CFU/ml.

This 10⁸ CFU/ml inoculum was centrifuged at 5000 rpm for 20 mins at 24° C. (Eppendorf Centrifuge 5810R with Eppendorf Swing-bucket rotor A-4-81), and the bacteria pellet was resuspended in 1/10 of the original inoculum volume in saline containing 5% of fetal bovine serum. The bacteria concentration in this inoculum is 10⁹ CFU/ml.

### Determination of Antibacterial Efficacy

Sterilized glass coverslips were placed into each well of a 6-well CytoOne® Plate and 20 μL of the 10⁹ CFU/ml bacteria inoculum prepared as described in above section was pipetted in a spot in the center of each coverslip. The plate was placed in an incubator at 36° C. for 25-35 mins until the inoculated bacteria was dry.

40 μL of composition was added to the inoculated coverslips ensuring that the area containing the bacteria was fully covered with the composition. The composition was kept in contact with the bacteria for 5 mins or any other contact time indicated in the examples. After this contact time, 5 ml of regular Letheen Broth was added to each well and the plate was placed in an orbital shaker set to 150 RPM for 5 minutes.

To determine the antibacterial efficacy of each composition, 1 ml of the Letheen Broth from each well was added to a commercial Neogen NF-TVC Soleris vial and bacteria growth was monitored at 34° C. for 24 hours in a Soleris Next Generation equipment. The Soleris Next Generation monitors microbial activity by CO₂ production. The time to detect bacteria growth in Soleris is proportional to the number of live bacteria remaining on the coverslip after treating with each composition, with longer growth detection times indicating compositions with better antibacterial efficacy, and no growth indicating complete kill. Positive control-bacteria with no treatment-, and negative control-clean coverslip nil bacteria-, were included in all the tests.

### Surface Shine Method

Filming/streaking is an important property of hard surface cleaning products as it influences the consumer's perception of the product's cleaning performance.

This test method enables the evaluation of the neat filming/streaking performance, also referred to as “shine profile” or simply “shine”, of different compositions on hard, black, glossy ceramic tiles of about 20 cm×25 cm under realistic conditions, using dry, white kitchen roll (Plenty UK brand or Bounty NA brand).

Prior to the test tiles are cleaned with a bleach containing hard surface cleaner by scrubbing vigorously with a clean sponge under hot water, rinsed and dried immediately with a white paper towel. After this wash step, tiles are treated with isopropylalcohol (IPA) or with ethanol, wiped with white paper towel and allowed to dry at room temperature. This washing and alcohol treatment steps ensure tiles are free of smears and particulates prior to each test.

Test compositions (225 μL) were applied diagonally from the bottom left corner to the top right corner of each respective tile, and wiped with a dry white kitchen paper towel of 8 cm×10 cm in a ‘3-M’ motion from left to right covering entire surface in 6 passes, this wiping pattern was then repeated, without lifting the paper towel from the tile, from top to bottom, and from right to left, finishing at the bottom right.

Tiles were left to dry flat on a bench for at least 20-30 minutes and graded by at least 3 panelists according to the grading scale shown below:
0—No streaks
1—Very Light Streaks
2—Light Streaks
3—Light to Medium Streaks
4—Medium Streaks
5—Medium to Heavy Streaks
6—Heavy Streaks

### EXAMPLES

### Example 1. Antimicrobial Efficacy

Table 1 shows the antibacterial efficacy and the surface shine scores of comparative compositions C-1 and C-2 outside the scope of the present invention, and of inventive compositions A-1, A-2, A-3, and A-4. Antibacterial efficacy was measured against S. aureus on glass surfaces under soiled conditions at 5 minutes contact time. The data shown are time in hours to detect bacterial growth by CO₂ production using commercial Neogen NF-TVC Soleris vials and a Soleris equipment (Soleris® Next Generation system). Bacterial growth was monitored for 24 hours. Longer time to detect growth indicates better antibacterial efficacy. If growth is not detected during the 24 h period, we consider that the treatment with the composition results in complete kill of the bacterial inoculum.

From the data of comparative compositions C-1 and C-2 vs inventive composition A-1 having different acid systems at equal total acid level it can be seen that the combination of citric acid, formic acid and alkyl polyglucoside surfactant, provides much better antibacterial efficacy while maintaining excellent shine, than the combination of lactic acid and glycolic acid (C-1) that has good shine but low antibacterial efficacy, and the combination of lactic acid and tartaric acid (C-2) that shows low antibacterial efficacy and the worst shine score of all the samples.

Inventive compositions A-2, A-3, and A-4 further illustrate the invention and show that the combination of C₈-C₁₀ alkyl polyglucoside surfactant with citric acid and formic acid provides excellent antibacterial efficacy while maintaining very good surface shine.

TABLE 1

| | C1 | C2 | A1 | A2 | A3 | A4 |
|---|---|---|---|---|---|---|
| C₈-C₁₀ APG (1) | 1.75% | 1.75% | 1.75% | 0.88% | 0.44% | 1.15% |
| Citric acid | — | — | 2% | 1% | 0.5% | 3% |
| Lactic Acid | 2% | 1% | — | — | — | — |
| Formic acid | — | — | 1% | 0.49% | 0.25% | 0.3% |
| Glycolic acid | 1% | — | — | — | — | — |
| Tartaric acid | | 2% | | | | — |
| Polymer (2) | 0.65% | — | 0.65% | — | — | — |
| Glycol ether | | — | | 0.4% | 0.4% | — |
| Solvent (3) | | | | | | |
| Minors (4) | | 0.04% | 0.04% | 0.031% | 0.031% | 0.04% |
| Water | | | To 100% | To 100% | To 100% | To 100% |
| pH | 2.5 | 2.5 | 2.5 | 2.2 | 2.2 | 2.4 |
| Antimicrobial | 12.15 | 13.45 | No | No | No | No |
| Efficacy | | | growth | growth | growth | growth |
| Time (h) to | | | Total | Total | Total | Total |
| detect growth | | | Kill | Kill | Kill | Kill |
| in Soleris. | | | | | | |
| S. aureus 5 | | | | | | |
| mins | | | | | | |
| Shine Score | 0.3 | 2 | 1 | 0.2 | 0.3 | 1.3 |

(1) Glucopon 215 UP BASF
(2) Copolymer of maleic acid and methyl vinyl ether. Gantrez S-95. Ashland
(3) Propylene Glycol n-Butyl Ether- Dowanol PnB- DOW
(4) Antifoam and perfume (A2 and A3). Perfume (C2, A1, A4)

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aqueous acidic hard surface cleaning liquid composition comprising by weight of the composition:
(a) from about 0.10 wt % to about 2.5 wt % alkyl polyglucoside surfactant;
(b) from about 0.15 wt % to about 4.00 wt % citric acid; and
(c) from about 0.05 wt % to about 1.00 wt % formic acid;
wherein the composition has a pH in the range of from about 1.9 to about 3.5.

2. The composition of claim 1, wherein the composition comprises, by weight of the composition:
(a) from about 0.175 wt % to about 3.0 wt % citric acid; and
(b) from about 0.050 wt % to about 0.5 wt % formic acid,
wherein the weight ratio of citric acid to formic acid is in the range of from about 60:1 to about 2.0:1.

3. The composition according to claim 1, wherein the composition comprises, by weight of the composition:
(a) from about 0.5 wt % to about 1.5 wt % citric acid; and
(b) from about 0.050 wt % to about 0.35 wt % formic acid,
wherein the weight ratio of citric acid to formic acid is in the range of from about 30:1 to about 3.0:1.

4. The composition according to claim 1, wherein the composition further comprises, by weight of the composition, from about 0.05 wt % to about 0.8 wt % glycolic acid.

5. The composition according to claim 1, wherein the composition comprises, by weight of the composition, from about 0.10 wt % to about 2.00 wt % alkyl polyglucoside surfactant.

6. The composition according to claim 1, wherein the composition comprises, by weight of the composition, from about 0.10 wt % to about 1.00 wt % alkyl polyglucoside surfactant.

7. The composition according to claim 1, wherein the alkyl polyglucoside surfactant is a C₈-C₁₀ alkyl polyglucoside surfactant.

8. The composition according to claim 1, wherein the composition further comprises, by weight of the composition, from about 0.1 wt % to about 1.0 wt % ether alcohol solvent.

9. The composition according to claim 8, wherein the ether alcohol solvent is selected from dipropylene glycol n-butyl ether, propylene glycol mono-butyl ether, propylene glycol phenyl ether, and any combination thereof.

10. The composition according to claim 1, wherein the composition further comprises one or more of the following ingredients selected from perfume, pH stabilizer, dye, antifoam agent, polymer, additional surfactant, preservative, chelant, hydrotrope, and any combination thereof.

11. The composition according to claim 1, wherein the composition comprises, by weight of the composition, from about 88 wt % to about 99.65 wt % water.

12. A cleaning kit for cleaning and sanitizing a hard surface, wherein the kit comprises:
(a) an aqueous acidic hard surface cleaning liquid composition according to claim 1;
(b) a handle;
(c) a support head pivotally attached to said handle;
(d) a disposable cleaning substrate removably attached to the support head; and
(e) a liquid delivery system for providing the cleaning liquid composition (a) to a surface to be cleaned and sanitized.

13. The cleaning kit according to claim 12, wherein the aqueous acidic hard surface cleaning liquid composition comprises, by weight of the composition:
(a) from about 0.1 wt % to about 1 wt % C₈-C₁₀ alkyl polyglucoside surfactant;
(b) from about 0.5 wt % to about 1.5 wt % citric acid;
(c) from about 0.1 wt % to about 0.3 wt % formic acid, and
(d) from about 0.1 wt % to about 0.7 wt % glycol ether solvent,
wherein the pH of the liquid cleaning composition is from about 1.9 to about 2.8.

14. The cleaning kit according to claim 12, wherein the aqueous acidic hard surface cleaning liquid composition further comprises, by weight of the composition, from about 0.05 wt % to about 0.4 wt % glycolic acid.
